(19) United States
(12) Patent Application Publication
(10) Pub. No.: US 2005/0005143 A1
(43) Pub. Date: Jan. 6, 2005

(54) System and method for the copy-protected and use-protected coding and decoding transmission and storage of electronic audio and visual media

(76) Inventors: Juergen K Lang, Gladbach (DE); Ursula Maria Bing, Bergisch Gladbach (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/495,385

(22) PCT Filed: Dec. 3, 2002
(86) PCT No.: PCT/DE02/04420

(30) Foreign Application Priority Data
Dec. 30, 2001 (DE) 101 64 135.4

(51) Int. Cl. H04L 9/32

(52) U.S. Cl. 713/193

(57) ABSTRACT

The invention relates to a system and to a method for copy-protected and utilization-protected encryption and decryption, transmission and storage of electronic audio and video media, whereby the data contents of the electronic media are processed, modulated and encrypted in such a way that their complete playback or display requires the execution of cryptographic decryption processes at the recipient who is authorized within a certain scope of utilization, and that, already during the encryption, it is possible to dynamically define the extent by which the display and playback quality as well as the utilization possibilities will be diminished if such cryptographic decryption processes are not carried out. According to the invention, this objective is achieved in that the electronic audio and video data is dynamically divided into unencrypted media data and useful data, encrypted media data and useful data, crypto-melody data and key data containing keys which, after a transmission and a secure decryption at the recipient, allow and cost-efficiently ensure proper utilization, particularly storing, displaying and playing in real time.

The invention relates to a system and to a method for copy-protected and utilization-protected encryption and decryption, transmission and storage of electronic audio and video media, whereby the data contents of the electronic media are processed, modulated and encrypted in such a way that their complete playback or display requires the execution of cryptographic decryption processes at the recipient who is authorized within a certain scope of utilization, and that, already during the encryption, it is possible to dynamically define the extent by which the display and playback quality as well as the utilization possibilities will be diminished if such cryptographic decryption processes are not carried out.

It is known that digital electronic media are processed, modulated and encrypted by means of various methods and systems for various purposes. In audio and video technology, such processes are normally carried out in order to render the digital data representing the analog audio signals especially (1) high-quality, (2) robust or (3) compact, or else (4) to disrupt unauthorized playback.

1)

Regarding the high quality, the objective is to acquire the analog audio signal as completely as possible with the digital data. Favorite examples of modulation, that is to say, the way in which analog audio signals are digitally acquired, are pulse code modulation (PCM) in which the amplitude of the audio signal is sampled in absolute values at regular intervals, or delta modulation in which the amplitude changes within a certain period of time are acquired. In the digitalization an analog signals, among other things, the so-called sampling rate plays a role, that is to say, the time frequency at which the amplitude of an audio signal is measured (twice the highest measurable and playable audio frequency, e.g. 44.1 kHz), as well as the precision of the storage of the measured frequency value (rounded off, for example, to 16 bits).

2)

Regarding the robustness of the data, the objective is to recognize or correct digital errors that occur. This is achieved, among other things, through the appropriate insertion of additional information (so-called redundancies) and the time-shifting and nesting of the digital data stream relative to the original analog audio signal, in order to distribute larger digital errors among several and perhaps even remediable smaller errors in the analog signal that is re-created later on. A popular method used in the CD system, for example, is the error correction according to Reed-Solomon.

3)

Regarding the compactness of the data, the objective is to reduce the amount of the data to be transmitted or stored to a minimum. With so-called compression methods, a distinction is made between quality-reducing methods (irreversible compression) and methods without quality loss (reversible compression). However, an avoidance of quality and information losses is only possible by reducing and thus losing important additional information or redundancies, so that permanently powerful compression methods are generally irreversible. The objective of high-quality compression methods such as, for example, the popular mpeg/mp3 method for compressing audio and video data is to reduce the data volume to a far greater extent than the subjectively (hardly) perceptible quality loss.

4)

The disruption of unauthorized playback is used especially in the analog TV sector in order to only allow complete playback when a special decoder is used. Since the decryption of the video signal in such a decoder is normally simple (analog phase shifting), this approach can also be fundamentally considered to fall in the general realm of encryption. Particularly, cryptographic encryptions can be fundamentally relevant for other application cases as well, for example, for the electronic transmission of audio and video data. In any case, data values that are relevant for the representation of the analog signal (e.g. amplitudes or phase values) are encrypted, for example, at the sender, in such a way that only an authorized recipient succeeds in performing a decryption. Symmetrical or asymmetrical methods or a combination of both (hybrid methods) are often employed. With symmetrical methods, the sender and the recipient have to have the same secret key which, for security reasons, has to be exchanged ahead of time via a different transmission channel. As an alternative, in order to avoid the exchange of the sensitive symmetrical key, asymmetrical methods are used in which, as a rule, the sender and the recipient each have an asymmetrical pair of keys consisting of a private and a public key. Whereas the private key always remains with the owner, the public keys can be distributed and exchanged freely. With the principle of asymmetrical encryption, data that is encrypted with the public key of a recipient can only be decrypted with the recipient's private key. Consequently, the encryption of digital data can be secured without exchanging secrets.

The problem with all of the known methods for modulation, error correction, compression and encryption lies in the fact that these methods pursue the objective of using the smallest possible amount of digital data to represent analog signals that, after being decoded into the analog domain, are subjectively perceived as being of high quality. Thus, due to their application purpose, neither modulation nor error correction nor compression are capable of protecting digital media against the creation of pirated copies or against unauthorized use. Moreover, the additional encryption of data only brings about a partial protection (e.g. within the scope of the data transmission), since after the decryption, the digital audio and video data is present once again in unencrypted form and can be freely copied with or without authorization. All in all, it needs to be pointed out for the known methods that they merely serve to represent (analog) audio and video signals in the digital domain as audio and video data. Any kind of encryption going beyond this is only temporary and is reversed even before the decoding, that is to say, before the re-conversion from the digital into the analog realm.

In spite of all of the safeguarding methods and security mechanisms, including, for example, those used to protect modern DVD media, the quintessence is that the digital audio and video data are present unencrypted and thus unprotected against the creation of unauthorized copies and against unauthorized use as soon as they leave the more or less shielded area of the playing and processing equipment. Particularly before the backdrop of open data transmissions in the Internet, this is a considerable drawback.

The invention is based on the objective of improving existing systems and methods for the modulation and encryption of electronic audio and video media and their data contents in such a way that these are processed, modulated and encrypted in such a manner that their complete playback or display requires the execution of cryptographic decryption processes at the recipient who is authorized within a certain scope of utilization, and that, already during the encryption, it is possible to dynamically define the extent by which the display and playback quality as well as the utilization possibilities will be diminished if such cryptographic decryption processes are not carried out.

According to the invention, this objective is achieved in that the electronic audio and video data is dynamically divided into unencrypted media data and useful data, encrypted media data and useful data, crypto-melody data and key data containing keys which, after a transmission and a secure decryption at the recipient, allow and cost-efficiently ensure proper utilization, particularly storing, displaying and playing in real time.

An advantageous embodiment of the method and a preferred embodiment of the system are characterized in that the scope of the encryption is variable so that the ratio between the unencrypted or unenciphered portion and the encrypted or enciphered portion of the audio and video data can be chosen at will.

Here, it is advantageous for such a proportional division of the encrypted and unencrypted portion to likewise be variable over the course of time so that the scope of the encrypted portion can change during the playback of audio and video data.

Moreover, it is advantageous for the specification of the proportional scope of this division of encrypted and unencrypted audio and video data to be contained in the encrypted and/or unencrypted useful data.

Advantageously, the system and the method are characterized in that the crypto-melody data and/or the useful data contain information about the proper utilization of the encrypted data, that is to say, the conditions under which the data is allowed to be decrypted.

Here, it is advantageous for the conditions under which the data is allowed to be decrypted to likewise be variable over the course of time.

Moreover, it is advantageous for the conditions under which the data is allowed to be decrypted to contain information about the costs or the fee category of the particular use in terms of the type of use and the duration of use.

Moreover, it is advantageous for the conditions under which the data is allowed to be decrypted to contain information about whether a private or a specific or an unspecific commercial use is intended.

Moreover, it is advantageous for the conditions under which the data is allowed to be decrypted to contain information about whether and how often the audio and video media can still be played.

Moreover, it is advantageous for the conditions under which the data is allowed to be decrypted to contain information about how often the audio and video media can still be copied.

Finally, it is advantageous for the conditions under which the data is allowed to be decrypted to contain information about the genre or another content-based classification of the audio and video media.

An advantageous embodiment of the method and a preferred embodiment of the system are characterized in that the author, producer, processor or distributor of the electronic audio and video media completely or partially encrypts or enciphers the unencrypted initial data in such a way that said data is proportionally divided over the unencrypted and the encrypted media data.

It is advantageous for the electronic audio and video media to be completely or partially encrypted or enciphered at the author, producer, processor or distributor with a “melody” key that is contained in the crypto-melody data in unencrypted or encrypted form.

It is advantageous for the “melody” key that is used for partially or completely encrypting or enciphering the electronic audio and video media and that is contained in the crypto-melody data to be encrypted with a “media” key that is contained in the key data in encrypted or unencrypted form.

Likewise, it is advantageous for the “melody” key that is used for partially or completely encrypting or enciphering the electronic audio and video media and that is contained in the crypto-melody data to be valid for a certain period of time that is shorter than the audio and video data that is to be played.

It is advantageous for the “media” key that is used for the decryption of the “melody” keys contained in the crypto-melody data to be contained in the key data in encrypted or unencrypted form.

It is likewise advantageous for the “media” key contained in the key data to be, in turn, encrypted.

It is also advantageous for the encrypted “media” key that is contained in the key data and that is used to decrypt the “melody” keys contained in the crypto-melody data to be provided with a reliable digital signature.

It is likewise advantageous for the unencrypted useful data to contain information about the way in which and with which “main” keys and “media” keys the keys for partially or completely decrypting or deciphering the electronic audio and video media are encrypted.

An advantageous embodiment of the method and a preferred embodiment of the system are characterized in that the crypto-melody contains information encrypted in a time sequence that, after being decrypted, can be used, in turn, to decrypt the encrypted media data.

Here, it is advantageous for the crypto-melody to be encrypted with the “media” key that was used for the encryption of the electronic audio and video media at the author, producer, processor or distributor and that is contained in the key data.

Moreover, it is advantageous for the media data to be decrypted with the “melody” keys contained in the crypto-melody in a manner entailing less computing work than an assumed decryption of the media data encrypted with the “media” key.

Moreover, it is advantageous for accompanying information about the audio and video data such as title, performers, etc. to be contained in the unencrypted useful data.

Moreover, it is also advantageous for additional accompanying information that is only to be offered or published for a fee to be contained in the encrypted useful data.

Additional advantages, special features and practical embodiments of the invention ensue from the subclaims and from the presentation below of preferred embodiments.

The present method and system is to be introduced by several companies in the media industry under the project designation “m.sec”. Below, the special features of m.sec are described.

With the advent of methods and systems for digital audio and video storage, a new level of sound media piracy arose: through so-called “sampling”, the audio and video signals, which had previously existed only in analog form, were unambiguously quantified within the scope of digitalization. Thanks to this unambiguous quantification, for example, in the form of bits and bytes with unambiguous values, perfect copies could be produced for the first time which could no longer be distinguished from the original and which thus suffered no qualitative degradation.

After sound media piracy had already acquired a substantial scope in the form of illegally produced CD copies with the spread of the compact disc, this piracy intensified even further with the advent of the Internet. Due to the large data volume, this was not so much a case of CD copies or audio files in the CD format but rather, sound media piracy was facilitated by a new data format, with which—due to its great compressability—small files could be created that could easily be exchanged via the Internet: the so-called “MP3” format.

MP3 was particularly promoted by the Internet swap network “Napster” which—partially on the edge of legality and partially outside of the law—offered allegedly private exchange transactions between Internet users in a public framework, thereby fostering the illegal transmission of music titles to third parties.

At the latest since MP3 and Napster, the media industry has felt that there is a greater need for a new data format for audio and video data. M.sec meets this need by offering the following advantages:
Digital audio and video data is no longer published unencrypted so that no perfect pirated copies of this original data can be produced.
The audio and video data at the recipient is only decrypted in exchange for payment of a user fee.
Here, variable user fees can be charged.
It is also possible to play parts of the audio and video data (e.g. the first few seconds of a piece of music or the lead of a film) without payment of a user fee.
It is possible to play any parts of the audio and video data without payment of a user fee but with a diminished quality.
The encrypted audio and video data can be provided with certain utilization rights (e.g. the number of times it can be played and copied) as well as other additional information.
When the audio and video data are played, the data is likewise not transferred unencrypted. Decryption only takes place at the time of the so-called digital-analog conversion (D/A conversion).
With the appropriate utilization rights, the recipient can create copies of the audio and video data after payment of a user fee.
These personal copies of the audio and video data are “released” and from then on can be played without further payment of license fees.
Such copies of the audio and video data that the recipient has created after payment of a user fee cannot be readily used by other recipients.

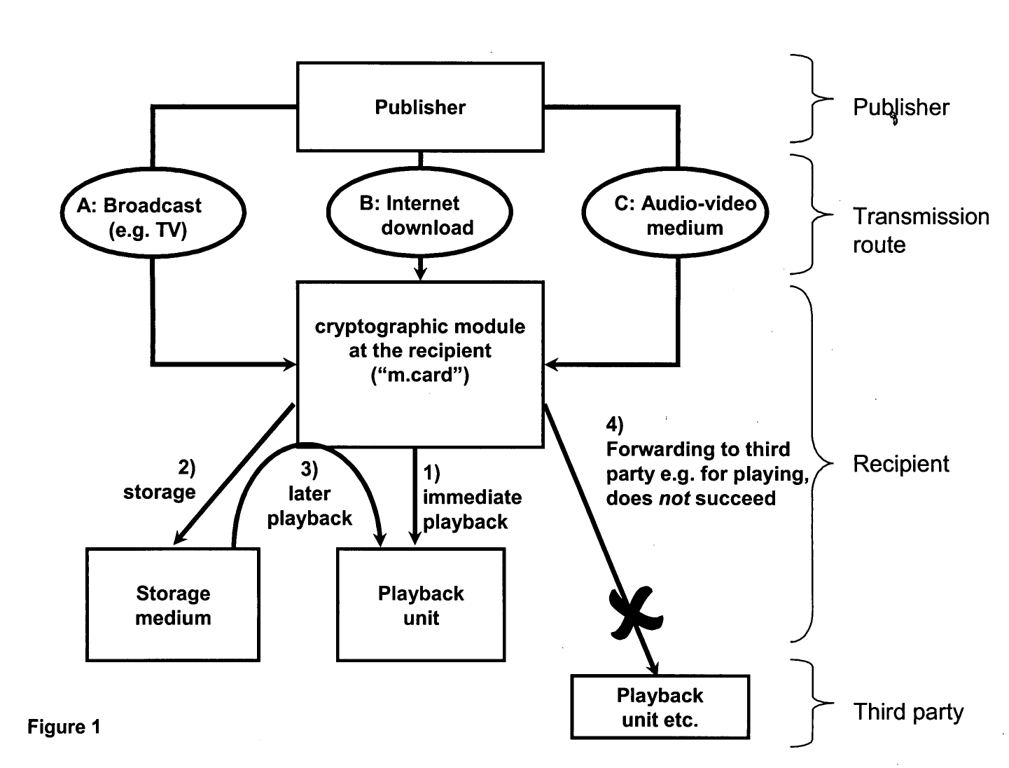

In order to meet these requirements, m.sec comprises the following architecture:
The so-called “publisher” distributes electronic audio and video data that is entirely or partially encrypted. (see “publisher” in FIG. 1)
The recipient has an individual, personalized chip card (the so-called m.card) which, as a cryptographic module, provides functionalities that the recipient cannot manipulate (see “cryptographic module at the recipient, m.card” in FIG. 1)
Appropriate playback and display devices (e.g. personal computer, CD player, Walkman, TV, etc.), in conjunction with the insertable chip card (m.card), offer the possibility to correctly play encrypted audio and video data.

FIG. 1 shows the three possible transmission routes, designated as A, B and C:
With transmission route A (e.g. television), there is a continuous and direct reception of the audio and video data, in the extreme case, in an uninterrupted data stream without beginning or end (so-called “streaming”).
With transmission route B, there is a remote transmission of audio and video media (e.g. as an Internet download) as a rule, in the form of dedicated, complete files.
With transmission route C, the audio and video information is available at the recipient on physically provided audio and video media (e.g. CDs or DVDs).

Here, the following scenarios of use are provided:

1. Playback of transmitted audio and video media (e.g. broadcast TV program)

If completely or partially encrypted contents of audio and video media are to be received and played immediately, then the m.card serves as the re-encrypting instrument between the encryption by the publisher and the playback unit.

Here, the encryption by the publisher in the m.card is reversed by means of decryption, the right to play is checked and the playback is initiated. As a rule, this re-encrypting is associated with costs that can be administered, for example, in the cryptographic module. In FIG. 1, this corresponds to the transmission route A in conjunction with the measure at the recipient designated by the number 1), namely, immediate playback.

2. Download and personal release of audio and video data for subsequent playback

If completely or partially encrypted contents are to be loaded, for example, downloaded from the Internet and released for later personal use, then the m.card serves as a re-encrypting instrument between the encryption by the publisher and the personal encryption with the m.card. As a rule, this re-encrypting is associated with costs that can be administered, for example, in the cryptographic module. In FIG. 1, this corresponds to the transmission route B in conjunction with the measure at the recipient designated by the number 2), namely, the local storing of the information.

Here, the encryption by the publisher in the m.card is reversed by means of decryption, the right to create a local copy is checked, the encryption with the m.card's own key is carried out and the generation of a copy is initiated.

3. Playback of audio and video data that has been provided by the author on physical media

If completely or partially encrypted contents of audio and video media are to be played which are provided on physical media, then the m.card serves as a re-encrypting instrument between the encryption by the publisher and the playback unit.

Here, the encryption by the publisher in the m.card is reversed by means of decryption, the right to play is checked and the playback is initiated. As a rule, this re-encrypting is associated with costs that can be administered, for example, in the cryptographic module. In FIG. 1, this corresponds to the transmission route C in conjunction with the measure at the recipient designated by the number 1), namely, immediate playback.

If the audio and video information is not temporarily stored in the re-encrypted state as shown in Item 2 in FIG. 1, then, for purposes of repeated playback of the data that has not been re-encrypted, the information can be securely saved by means of the first-time decryption of precisely specified audio and video data either in the cryptographic module itself or else outside of the cryptographic module, provided with a digital signature of the cryptographic module.

4. First and repeated playback of personally released audio and video data

If contents of audio and video media that have been released and encrypted again with the m.card's own key are to be played back, then the m.card serves as the re-encrypting instrument. As a rule, this re-encrypting is free of charge since a one-time fee for the release was already charged at the time of the original storing. operation In FIG. 1, this corresponds to the measure at the recipient designated by the number 3), namely, later playback.

Here, the actual encryption of the m.card is reversed in the m.card by means of decryption and the playback is initiated.

5. Forwarding personally released audio and video data to (unauthorized) third parties

If contents of audio and video media that have been released and encrypted again with the m.card's own key are forwarded to third parties, then the latter does not have the possibility to decrypt them, so that the production of pirated copies is not possible. In FIG. 1, this corresponds to the measure at the recipient designated by the number 4), namely, forwarding to third parties.

Forwarding to third parties (optional) of released audio and video data that can be made public again

If contents of audio and video media (e.g. for a separate fee) are released so that they can be made public again and if they are encrypted again with the m.card's own key, then forwarding to third parties is possible. For third parties, however, the possibility of decryption then exists (e.g. for a fee), in the same manner as this is possible for audio and video data that comes directly from publishers.

Coding the Audio and Video Data:

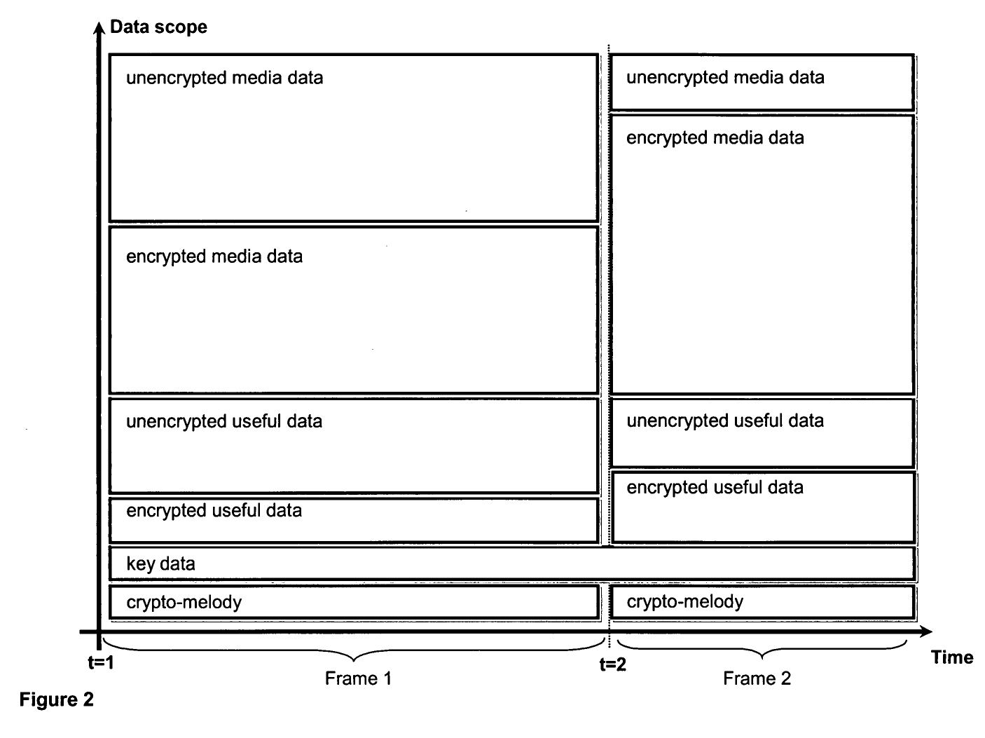

Audio and video data is divided into time blocks, so-called “frames” having a certain length. The sequence of frames results in the contents of the audio and video media. FIG. 2 below illustrates the division into frames and sectors.

Within each frame (in FIG. 2 there are two consecutive frames—marked as Frame 1 and Frame 2—on the horizontal time axis), there is a breakdown into six sections (these six sections are depicted in FIG. 2 as rectangles stacked on each other whose height yields the data scope on the vertical axis). These six sections are the following:
1. unencrypted media data (“media.plain”) that can be played without decryption,
2. encrypted media data (“media.cypher”) that is encrypted with the current “melody” key contained in the crypto-melody for this frame,
3. unencrypted useful data (“data.plain”) that contains information about the title, performer, about the classification and indication, about the genre, about accompanying information and, last but not least, about the time sequence (clock) (a complete set of unencrypted useful data can extend over several frames),
4. encrypted useful data (“data.cypher”) that is encrypted with the current “melody” key contained in the crypto-melody for this frame and that likewise contains various pieces of information about the title, etc. as well as accompanying and verification information and information about utilization rights (a complete set of encrypted useful data can extend over several frames),
5. key data (“media.key”) that contains an encrypted “media” key that can be used to decrypt the encrypted “melody” keys in the crypto-melody and that contains a digital signature or a certificate of this “media” key from a reliable source (certification authority) by means of which the proper ownership and use of this key can be checked (a complete set of key data can extend over several frames) and
6. the so-called “crypto-melody” (“melody.key”) that contains temporary “melody” keys that are encrypted with the “media” key and that are used to decrypt the encrypted media data as well as information on the authorized use of the audio and video media, relative to the frame in question. As a rule, a “melody” key always relates to one frame. However, it is possible to use “melody” keys that are valid over several frames.

The key data is optional and, if appertaining keys do not have to be added to the media data, they can be dispensed with or else replaced by filler data.

The proportion between unencrypted and encrypted media data and useful data can differ from one frame to another and, by the same token, the length of frames can vary. Key data and optionally also useful data can be distributed over several frames (especially in the case of long keys and additional information). See FIG. 2.

Structuring and Using the Crypto-Melody

The crypto-melody is an essential security element that markedly increases the overall security of the transmitted data in comparison to conventional methods, without requiring too much additional cryptographic computing work. The core of the crypto-melody is a random number that serves as a temporary “melody” key and whose validity extends over one frame as a rule. This temporary key can decrypt the encrypted media data and the encrypted useful data.

In order to make the temporary “melody” keys available to the recipient in a protected manner, these keys are contained in turn, in encrypted form in the crypto-melody. The temporary “melody” keys are encrypted by the so-called “media” key of the publisher who uses it, for example, over a period of one year.

In order to protect the “media” key and to transport it to the recipient, said “media” key—if necessary—once again in encrypted form, is contained in the key data. The “media” key is encrypted by the so-called “main” key that is available in a specially secured cryptographic module at the recipient and that consequently does not have to accompany the audio and video data.

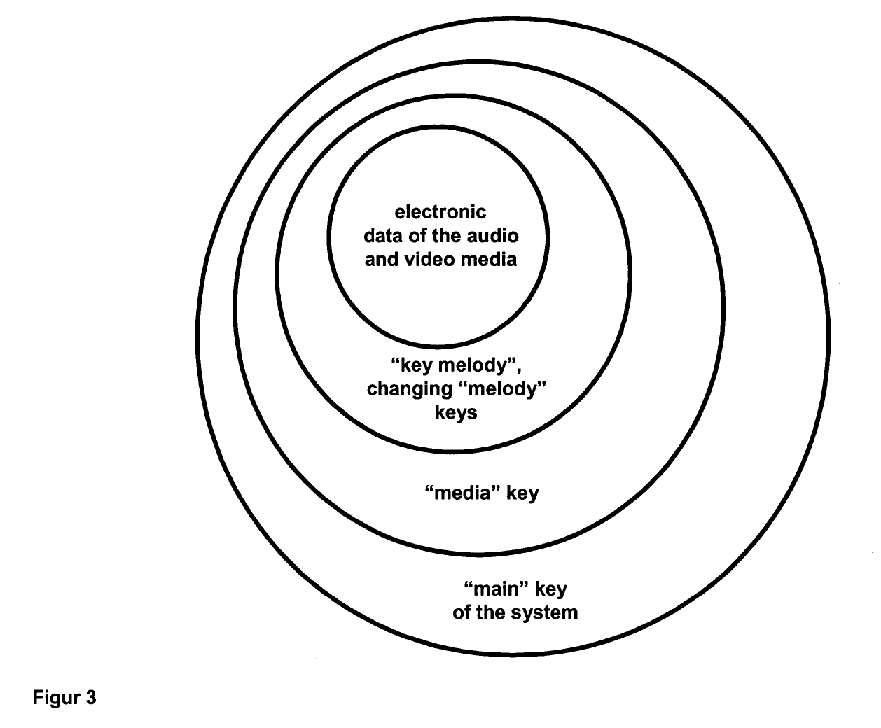

The reason for this multi-stage encryption, which is illustrated in FIG. 3 below in the so-called “shell model”, is a protection against attacks on the encrypted data with the objective of unauthorized decryption of the audio and video data. The protection extends like “shells” so to speak over the use of several keys in such a way that each key is used to the smallest extent possible.

In FIG. 3, the actual electronic data of the audio and video media that are supposed to be protected are depicted in the inner circle of the “shell model”.

This audio and video data is encrypted with the “melody” keys of the next circle or of the surrounding shell. These “melody” keys are randomly determined, frequently changing keys whose validity lasts only for a certain period of time (or frame). Assuming that the “melody” key changes once per second, then this key encrypts a total of about 40,000 to 100,000 media values (and optionally also useful data). This number results when one assumes the sampling rate of 44,100 samples per second that is common for digital audio signals in compact discs.

The “melody” keys are now, in turn, encrypted with the “media” key that is depicted in the next circle or the surrounding shell. This “media” key is made available to publishers by a certification authority, for example, once per year. The “media” key is used for the encryption of every single “melody” key. Assuming 4000 “melody” keys or frames that change every second per medium and assuming 100 to 250 published media per year, the result is a total use of a “media” key for about 400,000 to 1,000,000 encryptions and decryptions.

The “media” key is, in turn, encrypted with the “main” key that is depicted in the outer circle or the outer surrounding shell. This “main” key is used for the lifetime of the cryptographic module m.card. Assuming that 4,000 to 10,000 “media” keys are issued to publishers every year, this key would be used a total of about 40,000 to 100,000 times over a validity period of ten years.

Due to the use of a temporary “melody” key from the crypto-melody for the direct encryption of the audio and video data, a detection of this key merely means that the audio and video data can be exposed for the duration of one single frame. A detection of this key by means of crypto-analysis is virtually impossible since, by definition, it is only used to encrypt a limited number of values (only in one frame). A detection of the key by a so-called “brute force” attack, that is to say, by “trying out” all possible key values, would theoretically b e possible if the unencrypted value of the encrypted audio and video data were known and could serve as a basis for the success of the attack. A decryption of data that is already present in the decrypted form, however, does not warrant this effort and is thus negligible.

By using the “media” key of the publisher to encrypt the temporary “melody” keys of the crypto-melody, its detection is made difficult in two ways. Since the number of frames is much smaller than that of the audio and video data itself, a “media” key that is only used once per frame is used much less often than a “media” key that would be used to encrypt audio and video data. Therefore, as a result of the relatively infrequent use of the “media” key, the risk of detection of the key by means of crypto-analysis is diminished since the more often a key is used, the more easily it can be detected by means of crypto-analysis. Moreover, since the values of the temporary “melody” key that are to be decrypted are random numbers, a brute force attack is virtually ruled out because of the lack of a target value.

By using the “main” key to encrypt the “media” key, its detection is likewise made difficult in two ways. Since the “main” key is only used rarely, namely, for example, once per publisher and per year, the risk of detection of the key by means of crypto-analysis is diminished since the more often a key is used, the more easily it can be detected by means of crypto-analysis. Furthermore, the few target values do not offer a sufficient basis for a brute force attack.

1. A system and a method for copy-protected and utilization-protected encryption and decryption, transmission and storage of electronic audio and video media, whereby the data contents of the electronic media are processed, modulated and encrypted in such a way that their complete playback or display requires the execution of cryptographic decryption processes at the recipient who is authorized within a certain scope of utilization, and that, already during the encryption, it is possible to dynamically define the extent by which the display and playback quality as well as the utilization possibilities will be diminished if such cryptographic decryption processes are not carried out, characterized in that the electronic audio and video data is dynamically divided into unencrypted media data and useful data, encrypted media data and useful data, crypto-melody data and key data containing keys which, after a transmission and a secure decryption at the recipient, allow and cost-efficiently ensure proper utilization, particularly storing, displaying and playing in real time.

2. The method according to claim 1, characterized in that the scope of the encryption is variable so that the ratio between the unencrypted or unenciphered portion and the encrypted or enciphered portion of the audio and video data can be chosen at will.

3. The method according to claim 1, characterized in that such a proportional division of the encrypted and unencrypted portion can likewise be variable over the course of time so that the scope of the encrypted portion can change during the playback of audio and video data.

4. The method according to claim 1, characterized in that the specification of the proportional scope of this division of encrypted and unencrypted audio and video data is contained in the encrypted and/or unencrypted useful data.

5. The method according to claim 1, characterized in that the crypto-melody data and/or the useful data contain information about the proper utilization of the encrypted data, that is to say, the conditions under which the data is allowed to be decrypted.

6. The method according to claim 5, characterized in that the conditions under which the data is allowed to be decrypted are likewise variable over the course of time.

7. The method according to claim 5, characterized in that the conditions under which the data is allowed to be decrypted contain information about the costs or the fee category of the particular use in terms of the type of use and the duration of use.

8. The method according to claim 5, characterized in that the conditions under which the data is allowed to be decrypted contain information about whether a private or a specific or an unspecific commercial use is intended.

9. The method according to claim 5, characterized in that the conditions under which the data is allowed to be decrypted contain information about whether and how often the audio and video media can still be played.

10. The method according to claim 5, characterized in that the conditions under which the data is allowed to be decrypted contain information about how often the audio and video media can still be copied.

11. The method according to claim 5, characterized in that the conditions under which the data is allowed to be decrypted contain information about the genre or another content-based classification of the audio and video media.

12. The method according to claim 1, characterized in that the author, producer, processor or distributor of the electronic audio and video media completely or partially encrypts or enciphers the unencrypted initial data in such a way that said data is proportionally divided over the unencrypted and the encrypted media data.

13. The method according to claim 12, characterized in that the electronic audio and video media are completely or partially encrypted or enciphered at the author, producer, processor or distributor with a “melody” key that is contained in the crypto-melody data in unencrypted or encrypted form.

14. The method according to claim 12, characterized in that the “melody” key that is used for partially or completely encrypting or enciphering the electronic audio and video media and that is contained in the crypto-melody data is encrypted with a “media” key that is contained in the key data in encrypted or unencrypted form.

15. The method according to claim 12, characterized in that the “melody” key that is used for partially or completely encrypting or enciphering the electronic audio and video media and that is contained in the crypto-melody data is valid for a certain period of time that is shorter than the audio and video data that is to be played.

16. The method according to claim 12, characterized in that the “media” key that is used for the decryption of the “melody” keys contained in the crypto-melody data is contained in the key data in encrypted or unencrypted form.

17. The method according to claim 12, characterized in that the “media” key contained in the key data is, in turn, encrypted.

18. The method according to claim 12, characterized in that the encrypted “media” key that is contained in the key data and that is used to decrypt the “melody” keys contained in the crypto-melody data is provided with a reliable digital signature.

19. The method according to claim 12, characterized in that the unencrypted useful data contains information about the way in which and with which “main” keys and “media” keys the keys for partially or completely decrypting or deciphering the electronic audio and video media are encrypted.

20. The method according to claim 12, characterized in that the crypto-melody contains information encrypted in a time sequence that, after being decrypted, can be used, in turn, to decrypt the encrypted media data.

21. The method according to claim 20, characterized in that the crypto-melody is encrypted with the “media” key that was used for the encryption of the electronic audio and video media at the author, producer, processor or distributor and that is contained in the key data.

22. The method according to claim 20, characterized in that the media data is decrypted with the “melody” keys contained in the crypto-melody in a manner entailing less computing work than an assumed decryption of the media data encrypted with the “media” key.

23. The method according to claim 20, characterized in that accompanying information about the audio and video data such as title, performers, etc. is contained in the unencrypted useful data.

24. The method according to claim 20, characterized in that additional accompanying information that is only to be offered or published for a fee is contained in the encrypted useful data.
